(19) United States
(12) Patent Application Publication
(10) Pub. No.: US 2015/0268576 A1
(43) Pub. Date: Sep. 24, 2015

(54) ELECTROSTATIC CHARGE IMAGE DEVELOPING TONER, ELECTROSTATIC CHARGE IMAGE DEVELOPER, DEVELOPER CARTRIDGE, PROCESS CARTRIDGE, AND IMAGE FORMING APPARATUS

(71) Applicant: FUJI XEROX CO., LTD., Tokyo (JP)

(72) Inventors: Yutaka SAITO, Kanagawa (JP); Satoshi INOUE, Kanagawa (JP); Yasuaki HASHIMOTO, Kanagawa (JP); Hiroshi KAMADA, Kanagawa (JP); Tsutomu FURUTA, Kanagawa (JP)

(21) Appl. No.: 14/590,302

(22) Filed: Jan. 6, 2015

(30) Foreign Application Priority Data
Mar. 20, 2014 (JP) 2014-058853

(51) Int. Cl. G03G 9/00

(52) U.S. Cl. CPC G03G 9/093

(57) ABSTRACT

An electrostatic charge image developing toner includes toner particles containing a binder resin and a colorant, and strontium titanate particles, wherein the strontium titanate particles have a volume average particle diameter of 800 nm to 10,000 nm, a maximum peak at a Bragg angle of 32.2° in CuKα characteristic X-ray diffraction, and a half-value width of the maximum peak equal to or greater than 0.5 degrees.

### CROSS-REFERENCE TO RELATED APPLICATIONS

This application is based on and claims priority under 35 USC 119 from Japanese Patent Application No. 2014-058853 filed Mar. 20, 2014.

### BACKGROUND

1. Technical Field

The present invention relates to an electrostatic charge image developing toner, an electrostatic charge image developer, a developer cartridge, a process cartridge, and an image forming apparatus.

2. Related Art

When performing electrophotographic image forming, a toner is used as a material for the image forming, and a toner containing toner particles containing a binder resin or a colorant, and an additive externally added to the toner particles is widely used, for example.

### SUMMARY

According to an aspect of the invention, there is provided an electrostatic charge image developing toner including:

toner particles containing a binder resin and a colorant; and

strontium titanate particles,

wherein the strontium titanate particles have a volume average particle diameter of 800 nm to 10,000 nm, a maximum peak at a Bragg angle of 32.2° in CuKα characteristic X-ray diffraction, and a half-value width of the maximum peak equal to or greater than 0.5 degrees.

### BRIEF DESCRIPTION OF THE DRAWINGS

Exemplary embodiments of the present invention will be described in detail based on the following figures, wherein:

FIG. 1 is a schematic configuration diagram showing an image forming apparatus according to the exemplary embodiment; and

FIG. 2 is a schematic configuration diagram showing a process cartridge according to the exemplary embodiment.

### DETAILED DESCRIPTION

Hereinafter, the exemplary embodiments which are examples of the invention will be described in detail.

### Electrostatic Charge Image Developing Toner

An electrostatic charge image developing toner according to the exemplary embodiment (also simply referred to as “toner”) is configured with toner particles containing a binder resin and a colorant, and strontium titanate particles.

Herein, the strontium titanate particles of the exemplary embodiment have a volume average particle diameter of 800 nm to 10,000 nm, a maximum peak at a Bragg angle of 32.2° in CuKα characteristic X-ray diffraction, and a half-value width of the maximum peak equal to or greater than 0.5 degrees.

In the related art, a technology using a toner containing strontium titanate particles is known, in order to remove discharge products, the toner particles, and external additives attached to a surface of an image holding member of an image forming apparatus. Since abrasion to the surface of the image holding member is applied by the strontium titanate particles, the toner containing the strontium titanate particles may prevent a colored stripe generated by the attached material on the surface of the image holding member.

When output of low density images (image density equal to or less than 1%) having low consumption of the toner is continuous in an environment of a high temperature and high humidity (28.5° C. and 85% RH), the toner containing the strontium titanate particles continuously receives mechanical loads, and accordingly the strontium titanate particles are easily embedded in the toner particles, and the abrasion to the surface of the image holding member hardly appears. Thus, it may be difficult to prevent the generation of a colored stripe.

With respect to this, by increasing a particle diameter of the strontium titanate particles and improving a function as an external additive (spacer function), it is possible to prevent the generation of the colored stripe, even when the output of images having low image density is continuous in an environment of a high temperature and a high humidity. However, when the particle diameter of the strontium titanate particles is simply increased, the strontium titanate particles may be affected and dullness of color may be generated on the output image, in a case of strontium titanate particles having a high refractive index, for example.

That is, when the output of images having a low image density is continuous in an environment of a high temperature and a high humidity, it is difficult to prevent the generation of both the colored stripe and the dullness of color with just the toner using strontium titanate particles having a large particle diameter.

Therefore, in the toner according to the exemplary embodiment, strontium titanate particles having a volume average particle diameter of 800 nm to 10,000 nm, a maximum peak at a Bragg angle of 32.2° in CuKα characteristic X-ray diffraction, and a half-value width of the maximum peak equal to or greater than 0.5 degrees, are used.

The toner according to the exemplary embodiment which contains the strontium titanate particles having such physical properties with the toner particles containing a binder resin and a colorant, may prevent the colored stripe and the dullness of color generated when the output of images having a low image density is continuous in an environment of a high temperature and a high humidity.

A mechanism of realizing this effect is not clear, but may be supposed to be as follows.

It is considered that, when the particle diameter of the strontium titanate particles is from 800 nm to 10,000 nm which is a great particle diameter as that of the external additive, and the output of images having a low image density having low consumption of the toner is continuous in an environment of a high temperature and a high humidity, the strontium titanate particles are not embedded in the toner particles, the abrasion to the surface of the image holding member is maintained, and the generation of the colored stripe is prevented.

Meanwhile, the strontium titanate particles having a half-value width of the maximum peak (maximum peak at the Bragg angle of 32.2°) equal to or greater than 0.5 degrees caused by the strontium titanate particles in CuKα characteristic X-ray diffraction, indicate strontium titanate particles having low crystallinity (low degree of crystallinity), compared to a case where the half-value width is smaller than the range described above. Since strontium titanate particles having a low crystallinity have a low refractive index, compared to a case using strontium titanate particles having a high crystallinity (high degree of crystallinity), it is considered that the generation of the dullness of color may be prevented, even when the particle diameter is large as described above.

As described above, the toner according to the exemplary embodiment may prevent the colored stripe and the dullness of color generated when the output of images having a low image density is continuous in an environment of a high temperature and a high humidity.

Strontium Titanate Particles

First, the strontium titanate particles configuring the toner according to the exemplary embodiment will be described.

As described above, the strontium titanate particles contained in the toner are abrasive particles which may abrade the image holding member and one of external additives which are externally added to the surface of the toner particles.

Particle Diameter

The volume average particle diameter of the strontium titanate particles of the exemplary embodiment is from 800 nm to 10,000 nm, preferably from 900 nm to 7,000 nm, and more preferably from 1,000 nm to 5,000 nm.

When the volume average particle diameter of the strontium titanate particles is smaller than 800 nm, the strontium titanate particles are easily embedded in the toner particles when the output of images having a low image density is continuous, and it is difficult to prevent the generation of the colored stripe. When the volume average particle diameter thereof exceeds 10,000 nm, it is difficult to suppress the generation of the dullness of color, even when a half-value width of the maximum peak in CuKα characteristic X-ray diffraction is equal to or greater than 0.5 degrees.

The particle diameter of the strontium titanate particles is measured as follows.

That is, 100 primary particles of the strontium titanate particles (of the toner) after the strontium titanate particles are dispersed in the toner particles, are observed by a scanning electron microscope (SEM).

The maximum diameter and the minimum diameter for each particle are measured by image analysis of the primary particles, and an equivalent spherical diameter is measured from an average value thereof. The cumulative percentage of 50% diameter (D50v) of the obtained equivalent spherical diameters is set as the volume average particle diameter of the strontium titanate particles.

Crystallinity

The strontium titanate particles of the exemplary embodiment have a maximum peak at a Bragg angle of 32.2° in CuKα characteristic X-ray diffraction, and a half-value width of the maximum peak equal to or greater than 0.5 degrees.

Herein, in order to effectively prevent the generation of the colored stripe without decreasing the abrasion to the image holding member, the upper limit value of the half-value width of the maximum peak is preferably 2.0 degrees. The half-value width of the maximum peak is preferably from 0.7 degrees to 1.7 degrees and more preferably from 1.0 degree to 1.5 degrees.

When the half-value width of the maximum peak is smaller than 0.5 degrees, the crystallinity of the strontium titanate particles increases (high degree of crystallinity), the refractive index also increases, and it is difficult to prevent the generation of the dullness of color.

Herein, the X-ray diffraction measurement of the strontium titanate particles will be described.

The measurement of X-ray diffraction spectra of the exemplary embodiment is performed in the following conditions using CuKα characteristic X-rays by a powder method.

Conditions

Measuring instrument used: X-ray diffraction apparatus MINIFLEX manufactured by Rigaku Corporation

X-ray tube: Cu

Tube current: 15 mA

Scanning speed: 5.0 deg./min

Sampling interval: 0.02 deg.

Start angle (2θ): 5 deg.

Stop angle (2θ): 35 deg.

Step angle (2θ): 0.02 deg.

The identification of the X-ray diffraction peaks and the calculation of the half-value width of the peaks are performed using integrated X-ray powder diffraction software PDXL manufactured by Rigaku Corporation.

The strontium titanate particles are prepared by a well-known method such as a solid phase method or a liquid phase method.

The solid phase method is, for example, a method of mixing titanium oxide and oxide or carbonate of strontium with each other and burning these.

The liquid phase method is, for example, a method of causing metatitanic acid (hydrate of titanium oxide) and oxide or carbonate of strontium to react with each other in a water system and burning these.

By adjusting the conditions when performing the preparing described above, it is possible to control the diameter and the half-value width of the maximum peak of the strontium titanate particles. Particularly, by adjusting the conditions when performing the burning, it is possible to adjust the half-value width (degree of crystallinity) of the maximum peak of the strontium titanate particles.

In the same manner as the other external additives which will be described later, the surface of the strontium titanate particles may be subjected to a hydrophobizing treatment by a hydrophobizing agent.

Content

A content (externally added amount) of the strontium titanate particles may be from 0.05% by weight to 0.3% by weight and is preferably in a range of 0.1% by weight to 0.25% by weight, with respect to the toner particles.

When the content of the strontium titanate particles is in the range described above, the colored stripe and the dullness of color generated when the output of images having a low image density is continuous in an environment of a high temperature and a high humidity, are easily prevented.

When the strontium titanate particles are used with the other external additives which will be described later, a ratio of the strontium titanate particles used/other external additives may be from 0.005 to 0.1 and is preferably 0.01 to 0.075.

Toner Particles

The toner particles are configured to include a binder resin and a colorant, and if necessary, a release agent and other external additives.

Binder Resin

Examples of the binder resins include a homopolymer consisting of monomers such as styrenes (for example, styrene, p-chlorostyrene, α-methyl styrene, or the like), (meth)acrylic esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, or the like), ethylenic unsaturated nitriles (for example, acrylonitrile, methacrylonitrile, or the like), vinyl ethers (for example, vinyl methyl ether, vinyl isobutyl ether, or the like), vinyl ketones (for example, vinyl methyl ketone, vinyl ethyl ketone, vinyl isopropenyl ketone, or the like), olefins (for example, ethylene, propylene, butadiene, or the like), or a vinyl resin formed of a copolymer obtained by combining two or more kinds of these monomers.

Examples of the binder resin include a non-vinyl resin such as an epoxy resin, a polyester resin, a polyurethane resin, a polyamide resin, a cellulose resin, a polyether resin, and a modified rosin, a mixture of these and a vinyl resin, or a graft polymer obtained by polymerizing a vinyl monomer in the presence thereof.

These other binder resins may be used alone or in combination with two or more kinds thereof.

As the binder resin, a polyester resin is preferably used.

As the polyester resin, a well-known polyester resin is used, for example.

Examples of the polyester resin include polycondensates of polyvalent carboxylic acids and polyols. A commercially available product or a synthesized product may be used as the polyester resin.

Examples of the polyvalent carboxylic acid include aliphatic dicarboxylic acids (e.g., oxalic acid, malonic acid, maleic acid, fumaric acid, citraconic acid, itaconic acid, glutaconic acid, succinic acid, alkenyl succinic acids, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used alone or in combination of two or more kinds thereof.

Examples of the polyol include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic dials (e.g., ethylene oxide adducts of bisphenol A and propylene oxide adducts of bisphenol A). Among these, for example, aromatic diols and alicyclic diols are preferably used, and aromatic dials are more preferably used as the polyol.

As the polyol, a tri- or higher-valent polyol employing a crosslinked structure or a branched structure may be used in combination with a diol. Examples of the tri- or higher-valent polyol include glycerin, trimethylolpropane, and pentaerythritol.

The polyols may be used alone or in combination of two or more kinds thereof.

The glass transition temperature (Tg) of the amorphous polyester resin is preferably from 50° C. to 80° C., and more preferably from 50° C. to 65° C.

The glass transition temperature is acquired by a DSC curve obtained by differential scanning calorimetry (DSC). More specifically, the glass transition temperature is acquired by “extrapolating glass transition starting temperature” disclosed in a method of acquiring the glass transition temperature of JIS K7121-1987 “Testing Methods for Transition Temperatures of Plastics”.

A weight average molecular weight (Mw) of the polyester resin is preferably from 5,000 to 1,000,000, and more preferably from 7,000 to 500,000.

A number average molecular weight (Mn) of the polyester resin is preferably from 2,000 to 100,000.

A molecular weight distribution Mw/Mn of the polyester resin is preferably from 1.5 to 100, and more preferably from 2 to 60.

The weight average molecular weight and the number average molecular weight are measured by gel permeation chromatography (GPC). The molecular weight measurement by GPC is performed with a THF solvent using a GPC HLC-8120 GPC manufactured by Tosoh Corporation as a measurement device and a TSKGEL SUPER HM-M column (15 cm) manufactured by Tosoh Corporation. The weight average molecular weight and the number average molecular weight are calculated from results of this measurement using a calibration curve of molecular weights created with monodisperse polystyrene standard samples.

The polyester resin is obtained with a well-known preparation method. Specific examples thereof include a method of conducting a reaction at a polymerization temperature set to 180° C. to 230° C., if necessary, under reduced pressure in the reaction system, while removing water or alcohol generated during condensation.

When monomers of the raw materials do not dissolve or become compatibilized at a reaction temperature, a high-boiling-point solvent may be added as a solubilizing agent to dissolve the monomers. In this case, a polycondensation reaction is conducted while distilling away the solubilizing agent. When a monomer having poor compatibility is present in a copolymerization reaction, the monomer having poor compatibility and an acid or an alcohol to be polycondensed with the monomer may be previously condensed and then polycondensed with a major component.

The content of the binder resin is, for example, preferably from 40% by weight to 95% by weight, more preferably from 50% by weight to 90% by weight, and even more preferably from 60% by weight to 85% by weight, with respect to the entire toner particles.

Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, Rhodamine B Lake, Lake Red C, pigment red, rose bengal, aniline blue, ultramarine blue, calco oil blue, methylene blue chloride, phthalocyanine blue, pigment blue, phthalocyanine green, and malachite green oxalate, and various dyes such as acridine dyes, xanthene dyes, azo dyes, benzoquinone dyes, azine dyes, anthraquinone dyes, thioindigo dyes, dioxadine dyes, thiazine dyes, azomethine dyes, indigo dyes, phthalocyanine dyes, aniline black dyes, polymethine dyes, triphenylmethane dyes, diphenylmethane dyes, and thiazole dyes.

The colorants may be used alone or in combination of two or more kinds thereof.

If necessary, the colorant may be surface-treated or used in combination with a dispersing agent. Plural kinds of colorants may be used in combination thereof.

The content of the colorant is, for example, preferably from 1% by weight to 30% by weight, and more preferably from 3% by weight to 15% by weight with respect to the entirety of the toner particles.

Release Agent

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited thereto.

The melting temperature of the release agent is preferably from 50° C. to 110° C., and more preferably from 60° C. to 100° C.

The melting temperature of the release agent is obtained from “melting peak temperature” described in the method of obtaining a melting temperature in JIS K7121-1987 “Testing Methods for Transition Temperatures of Plastics”, from a DSC curve obtained by differential scanning calorimetry (DSC).

The content of the release agent is, for example, preferably from 1% by weight to 20% by weight and more preferably from 5% by weight to 15% by weight, with respect to the entirety of the toner particles.

Other Additives

Examples of other additives include known additives such as a magnetic material, a charge-controlling agent, and an inorganic powder. The toner particles contain these additives as internal additives.

Characteristics of Toner Particles

The toner particles may be toner particles having a single-layer structure, or toner particles having a so-called core/shell structure composed of a core (core particle) and a coating layer (shell layer) coated on the core.

Here, toner particles having a core/shell structure are preferably composed of, for example, a core containing a binder resin, and if necessary, other additives such as a colorant and a release agent, and a coating layer containing a binder resin.

The volume average particle diameter (D50v) of the toner particles is preferably from 2 μm to 10 μm, and more preferably from 4 μm to 8 μm.

Various average particle diameters and various particle size distribution indices of the toner particles are measured using a COULTER MULTISIZER II (manufactured by Beckman Coulter, Inc.) and ISOTON-II (manufactured by Beckman Coulter, Inc.) as an electrolyte.

In the measurement, from 0.5 mg to 50 mg of a measurement sample is added to 2 ml of a 5% aqueous solution of surfactant (preferably sodium alkylbenzene sulfonate) as a dispersing agent. The obtained material is added to 100 ml to 150 ml of the electrolyte.

The electrolyte in which the sample is suspended is subjected to a dispersion treatment using an ultrasonic disperser for 1 minute, and a particle size distribution of particles having a particle diameter of 2 μm to 60 μm is measured by a COULTER MULTISIZER II using an aperture having an aperture diameter of 100 μm. 50,000 particles are sampled.

Cumulative distributions by volume and by number are drawn from the side of the smallest diameter with respect to particle size ranges (channels) separated based on the measured particle size distribution. The particle diameter when the cumulative percentage becomes 16% is defined as that corresponding to a volume particle diameter D16v and a number particle diameter D16p, while the particle diameter when the cumulative percentage becomes 50% is defined as that corresponding to a volume average particle diameter D50v and a number average particle diameter D50p. Furthermore, the particle diameter when the cumulative percentage becomes 84% is defined as that corresponding to a volume particle diameter D84v and a number particle diameter D84p.

Using these, a volume average particle size distribution index (GSDv) is calculated as (D84v/D16v)^{1/2}, while a number average particle size distribution index (GSDp) is calculated as (D84p/D16p)^{1/2}.

The shape factor SF1 of the toner particles is preferably from 110 to 150, and more preferably from 120 to 140.

The shape factor SF1 is obtained through the following expression.

SF1=(ML²/A)×(π/4)×100 Expression:

In the foregoing expression, ML represents an absolute maximum length of a toner particle, and A represents a projected area of a toner particle.

Specifically, the shape factor SF1 is numerically converted mainly by analyzing a microscopic image or a scanning electron microscopic (SEM) image by the use of an image analyzer, and is calculated as follows. That is, an optical microscopic image of particles scattered on a surface of a glass slide is input to an image analyzer Luzex through a video camera to obtain maximum lengths and projected areas of 100 particles, values of SF1 are calculated through the foregoing expression, and an average value thereof is obtained.

Other External Additives

In the toner according to the exemplary embodiment, at least the strontium titanate particles described above are externally added to the toner particles, but other external additives may further be used in combination.

Examples of the other external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

Surfaces of the inorganic particles as an external additive are preferably subjected to a hydrophobizing treatment. The hydrophobizing treatment is performed by, for example, dipping the inorganic particles in a hydrophobizing agent. The hydrophobizing agent is not particularly limited and examples thereof include a silane coupling agent, silicone oil, a titanate coupling agent, and an aluminum coupling agent. These may be used alone or in combination of two or more kinds thereof.

Generally, the amount of the hydrophobizing agent is, for example, from 1 part by weight to 10 parts by weight with respect to 100 parts by weight of the inorganic particles.

Examples of the external additive also include resin particles (resin particles such as polystyrene, PMMA (polymethylmethacrylate), and melamine resin particles) and a cleaning aid (e.g., metal salt of a higher fatty acid represented by zinc stearate, and fluorine-based polymer particles).

The amount of the external additives externally added is, for example, preferably from 0.01% by weight to 5% by weight, and more preferably from 0.01% by weight to 2.0% by weight with respect to the toner particles.

Preparing Method of Toner

Next, a method of preparing a toner according to the exemplary embodiment will be described.

The toner according to the exemplary embodiment is obtained by externally adding an external additive to toner particles after preparing of the toner particles.

The toner particles may be prepared using any of a dry method (e.g., kneading and pulverizing method) and a wet method (e.g., aggregation and coalescence method, suspension and polymerization method, and dissolution and suspension method). The toner particle preparing method is not particularly limited to these methods, and a known method is employed.

Among these, the toner particles are preferably obtained by an aggregation and coalescence method.

Specifically, for example, when the toner particles are prepared by an aggregation and coalescence method, the toner particles are prepared through the processes of: preparing a resin particle dispersion in which resin particles as a binder resin are dispersed (resin particle dispersion preparation process); aggregating the resin particles (if necessary, other particles) in the resin particle dispersion (if necessary, in the dispersion after mixing with other particle dispersions) to form aggregated particles (aggregated particle forming process); and heating the aggregated particle dispersion in which the aggregated particles are dispersed, to coalesce the aggregated particles, thereby forming toner particles (coalescence process).

Hereinafter, the respective processes will be described in detail.

In the following description, a method of obtaining the toner particles containing the colorant and the release agent will be described, but the colorant and the release agent are only used, if necessary. Additives other than the colorant and the release agent may be used.

Resin Particle Dispersion Preparation Process

First, for example, a colorant particle dispersion in which colorant particles are dispersed and a release agent particle dispersion in which release agent particles are dispersed are prepared together with a resin particle dispersion in which resin particles as a binder resin are dispersed.

Herein, the resin particle dispersion is prepared by, for example, dispersing resin particles by a surfactant in a dispersion medium.

Examples of the dispersion medium used for the resin particle dispersion include aqueous mediums.

Examples of the aqueous mediums include water such as distilled water and ion exchange water, and alcohols. These may be used alone or in combination of two or more kinds thereof.

Examples of the surfactant include anionic surfactants such as sulfate ester salt, sulfonate, phosphate, and soap-based anionic surfactants; cationic surfactants such as amine salt and quaternary ammonium salt cationic surfactants; and nonionic surfactants such as polyethylene glycol, alkylphenol ethylene oxide adduct, and polyol nonionic surfactants. Among these, anionic surfactants and cationic surfactants are particularly used. Nonionic surfactants may be used in combination with anionic surfactants or cationic surfactants.

The surfactants may be used alone or in combination of two or more kinds thereof.

Regarding the resin particle dispersion, as a method of dispersing the resin particles in the dispersion medium, a common dispersing method using, for example, a rotary shearing-type homogenizer, or a ball mill, a sand mill, or a DYNO Mill having media is exemplified. Depending on the kind of the resin particles, resin particles may be dispersed in the resin particle dispersion using, for example, a phase inversion emulsification method.

The phase inversion emulsification method includes: dissolving a resin to be dispersed in a hydrophobic organic solvent in which the resin is soluble; performing neutralization by adding abase to an organic continuous phase (O phase); and converting the resin (so-called phase inversion) from W/O to O/W by adding an aqueous medium (W phase) to form a discontinuous phase, thereby dispersing the resin as particles in the aqueous medium.

The volume average particle diameter of the resin particles dispersed in the resin particle dispersion is, for example, preferably from 0.01 μm to 1 μm, more preferably from 0.08 μm to 0.8 μm, and even more preferably from 0.1 μm to 0.6 μm.

Regarding the volume average particle diameter of the resin particles, a cumulative distribution by volume is drawn from the side of the smallest diameter with respect to particle size ranges (channels) separated using the particle size distribution obtained by the measurement with a laser diffraction-type particle size distribution measuring device (for example, manufactured by Horiba, Ltd., LA-700), and a particle diameter when the cumulative percentage becomes 50% with respect to the entirety of the particles is measured as a volume average particle diameter D50v. The volume average particle diameter of the particles in other dispersions is also measured in the same manner.

The content of the resin particles contained in the resin particle dispersion is, for example, preferably from 5% by weight to 50% by weight, and more preferably from 10% by weight to 40% by weight.

For example, the colorant particle dispersion and the release agent particle dispersion are also prepared in the same manner as in the case of the resin particle dispersion. That is, the particles in the resin particle dispersion are the same as the colorant particles dispersed in the colorant particle dispersion and the release agent particles dispersed in the release agent particle dispersion, in terms of the volume average particle diameter, the dispersion medium, the dispersing method, and the content of the particles.

Aggregated Particle Forming Process

Next, the colorant particle dispersion and the release agent dispersion are mixed together with the resin particle dispersion.

The resin particles, the colorant particles, and the release agent particles heterogeneously aggregate in the mixed dispersion, thereby forming aggregated particles having a diameter near a target toner particle diameter and including the resin particles, the colorant particles, and the release agent particles.

Specifically, for example, an aggregating agent is added to the mixed dispersion and a pH of the mixed dispersion is adjusted to acidity (for example, the pH being from 2 to 5). If necessary, a dispersion stabilizer is added. Then, the mixed dispersion is heated at a temperature of the glass transition temperature of the resin particles (specifically, for example, from a temperature 30° C. lower than the glass transition temperature of the resin particles to a temperature 10° C. lower than the glass transition temperature) to aggregate the particles dispersed in the mixed dispersion, thereby forming the aggregated particles.

In the aggregated particle forming process, for example, the aggregating agent may be added at room temperature (for example, 25° C.) under stirring of the mixed dispersion using a rotary shearing-type homogenizer, the pH of the mixed dispersion may be adjusted to acidity (for example, the pH being from 2 to 5), a dispersion stabilizer may be added if necessary, and the heating may then be performed.

Examples of the aggregating agent include a surfactant having an opposite polarity to the polarity of the surfactant used as the dispersing agent added to the mixed dispersion, such as inorganic metal salts and di- or higher-valent metal complexes. Particularly, when a metal complex is used as the aggregating agent, the amount of the surfactant used is reduced and charging characteristics are improved.

If necessary, an additive may be used to forma complex or a similar bond with the metal ions of the aggregating agent. A chelating agent is preferably used as the additive.

Examples of the inorganic metal salts include metal salts such as calcium chloride, calcium nitrate, barium chloride, magnesium chloride, zinc chloride, aluminum chloride, and aluminum sulfate, and inorganic metal salt polymers such as polyaluminum chloride, polyaluminum hydroxide, and calcium polysulfide.

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added is, for example, preferably from 0.01 parts by weight to 5.0 parts by weight, and more preferably from 0.1 parts by weight to less than 3.0 parts by weight with respect to 100 parts by weight of the resin particles.

Coalescence Process

Next, the aggregated particle dispersion in which the aggregated particles are dispersed is heated at, for example, a temperature that is equal to or higher than the glass transition temperature of the resin particles (for example, a temperature that is higher than the glass transition temperature of the resin particles by 10° C. to 30° C.) to coalesce the aggregated particles and form toner particles.

Toner particles are obtained through the foregoing processes.

After the aggregated particle dispersion in which the aggregated particles are dispersed is obtained, toner particles may be prepared through the processes of: further mixing the resin particle dispersion in which the resin particles are dispersed with the aggregated particle dispersion to conduct aggregation so that the resin particles further adhere to the surfaces of the aggregated particles, thereby forming second aggregated particles; and coalescing the second aggregated particles by heating the second aggregated particle dispersion in which the second aggregated particles are dispersed, thereby forming toner particles having a core/shell structure.

After the coalescence process ends, the toner particles formed in the solution are subjected to a washing process, a solid-liquid separation process, and a drying process, that are well known, and thus dry toner particles are obtained.

In the washing process, preferably, displacement washing using ion exchange water is sufficiently performed from the viewpoint of charging properties. In addition, the solid-liquid separation process is not particularly limited, but suction filtration, pressure filtration, or the like is preferably performed from the viewpoint of productivity. The method for the drying process is also not particularly limited, but freeze drying, flash jet drying, fluidized drying, vibration-type fluidized drying, or the like is preferably performed from the viewpoint of productivity.

The toner according to the exemplary embodiment is prepared by, for example, adding and mixing an external additive containing the strontium titanate particles described above to and with dry toner particles that have been obtained.

The mixing is preferably performed with, for example, a V-blender, a Henschel mixer, a Löedige mixer, or the like.

Furthermore, if necessary, coarse toner particles may be removed using a vibration sieving machine, a wind-power sieving machine, or the like.

Electrostatic Charge Image Developer

An electrostatic charge image developer according to the exemplary embodiment includes at least the toner according to the exemplary embodiment.

The electrostatic charge image developer according to the exemplary embodiment may be a single-component developer including only the toner according to the exemplary embodiment, or a two-component developer obtained by mixing the toner with a carrier.

The carrier is not particularly limited, and known carriers are exemplified. Examples of the carrier include a coated carrier in which surfaces of cores formed of a magnetic particle are coated with a coating resin; a magnetic particle dispersion-type carrier in which magnetic particles are dispersed in and blended into a matrix resin; and a resin impregnation-type carrier in which a porous magnetic particle is impregnated with a resin.

The magnetic particle dispersion-type carrier and the resin impregnation-type carrier may be carriers in which constituent particles of the carrier are cores and have a surface coated with a coating resin.

Examples of the magnetic particle include magnetic metals such as iron, nickel, and cobalt, and magnetic oxides such as ferrite and magnetite.

Examples of the conductive particles include particles of metals such as gold, silver, and copper, carbon black particles, titanium oxide particles, zinc oxide particles, tin oxide particles, barium sulfate particles, aluminum borate particles, and potassium titanate particles.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin configured to include an organosiloxane bond or a modified product thereof, a fluororesin, polyester, polycarbonate, a phenol resin, and an epoxy resin.

The coating resin and the matrix resin may contain additives such as a conductive material.

Herein, a coating method using a coating layer forming solution in which a coating resin and, if necessary, various additives are dissolved in an appropriate solvent is used to coat the surface of a core with the coating resin. The solvent is not particularly limited, and may be selected in consideration of the type of coating resin to be used, coating suitability, and the like.

Specific examples of the resin coating method include a dipping method of dipping cores in a coating layer forming solution; a spraying method of spraying a coating layer forming solution onto surfaces of cores; a fluid bed method of spraying a coating layer forming solution in a state in which cores are allowed to float by flowing air; and a kneader-coater method in which cores of a carrier and a coating layer forming solution are mixed with each other in a kneader-coater and the solvent is removed.

The mixing ratio (weight ratio) between the toner and the carrier in the two-component developer is preferably from 1:100 to 30:100, and more preferably from 3:100 to 20:100 (toner:carrier).

Image Forming Apparatus/Image Forming Method

An image forming apparatus and an image forming method according to the exemplary embodiment will be described.

The image forming apparatus according to the exemplary embodiment is provided with an image holding member, a charging unit that charges a surface of the image holding member, an electrostatic charge image forming unit that forms an electrostatic charge image on a charged surface of the image holding member, a developing unit that accommodates an electrostatic charge image developer and develops the electrostatic charge image formed on the surface of the image holding member with the electrostatic charge image developer to forma toner image, a transfer unit that transfers the toner image formed on the surface of the image holding member onto a surface of a recording medium, and a fixing unit that fixes the toner image transferred onto the surface of the recording medium. As the electrostatic charge image developer, the electrostatic charge image developer according to the exemplary embodiment is applied.

In the image forming apparatus according to the exemplary embodiment, an image forming method (image forming method according to the exemplary embodiment) including a charging process of charging a surface of an image holding member, an electrostatic charge image forming process of forming an electrostatic charge image on a charged surface of the image holding member, a developing process of developing the electrostatic charge image formed on the surface of the image holding member with the electrostatic charge image developer according to the exemplary embodiment to form a toner image, a transfer process of transferring the toner image formed on the surface of the image holding member onto a surface of a recording medium, and a fixing process of fixing the toner image transferred onto the surface of the recording medium is performed.

As the image forming apparatus according to the exemplary embodiment, a known image forming apparatus is applied, such as a direct transfer-type apparatus that directly transfers a toner image formed on a surface of an image holding member onto a recording medium; an intermediate transfer-type apparatus that primarily transfers a toner image formed on a surface of an image holding member onto a surface of an intermediate transfer member, and secondarily transfers the toner image transferred onto the surface of the intermediate transfer member onto a surface of a recording medium; an apparatus that is provided with a cleaning unit that cleans a surface of an image holding member after transfer of a toner image and before charging; or an apparatus that is provided with an erasing unit that irradiates, after transfer of a toner image and before charging, a surface of an image holding member with erasing light for erasing.

In the case where the image forming apparatus according to the exemplary embodiment is an intermediate transfer-type apparatus, a transfer unit has, for example, an intermediate transfer member having a surface onto which a toner image is to be transferred, a primary transfer unit that primarily transfers a toner image formed on a surface of an image holding member onto the surface of the intermediate transfer member, and a secondary transfer unit that secondarily transfers the toner image transferred onto the surface of the intermediate transfer member onto a surface of a recording medium.

In the image forming apparatus according to the exemplary embodiment, for example, a part including the developing unit may have a cartridge structure (process cartridge) that is detachable from the image forming apparatus. As the process cartridge, for example, a process cartridge that accommodates the electrostatic charge image developer according to the exemplary embodiment and is provided with a developing unit is preferably used.

Hereinafter, an example of the image forming apparatus according to the exemplary embodiment will be described. However, this image forming apparatus is not limited thereto. The major parts shown in the drawing will be described, but descriptions of other parts will be omitted.

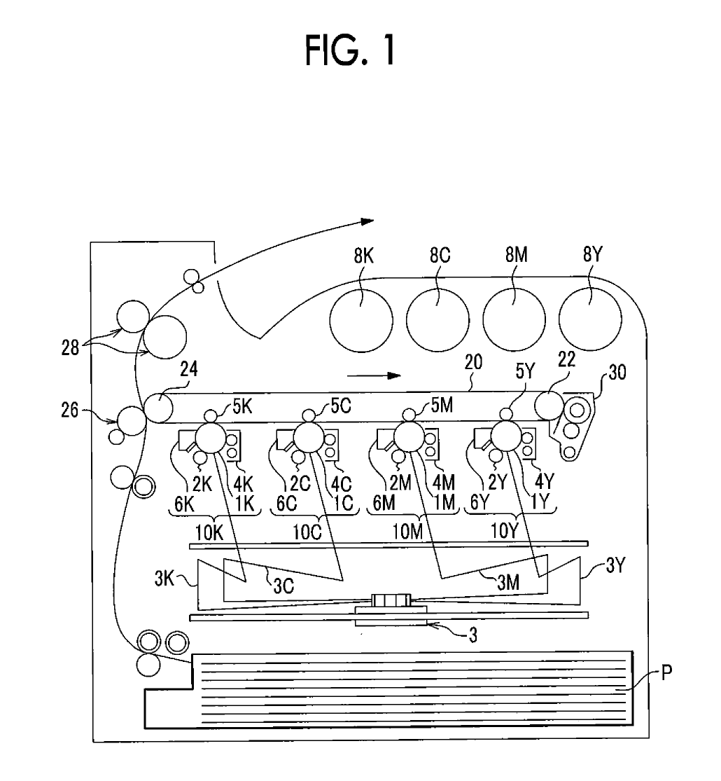

FIG. 1 is a schematic configuration diagram showing the image forming apparatus according to the exemplary embodiment.

The image forming apparatus shown in FIG. 1 is provided with first to fourth electrophotographic image forming units 10Y, 10M, 10C, and 10K (image forming units) that output yellow (Y), magenta (M), cyan (C), and black (K) images based on color-separated image data, respectively. These image forming units (hereinafter, may be simply referred to as “units”) 10Y, 10M, 10C, and 10K are arranged side by side at predetermined intervals in a horizontal direction. These units 10Y, 10M, 10C, and 10K may be process cartridges that are detachable from the image forming apparatus.

An intermediate transfer belt 20 as an intermediate transfer member is installed above the units 10Y, 10M, 10C, and 10K in the drawing to extend through the units. The intermediate transfer belt 20 is wound on a driving roll 22 and a support roll 24 contacting the inner surface of the intermediate transfer belt 20, which are disposed to be separated from each other on the left and right sides in the drawing, and travels in a direction toward the fourth unit 10K from the first unit 10Y. The support roll 24 is pressed in a direction in which it departs from the driving roll 22 by a spring or the like (not shown), and tension is given to the intermediate transfer belt 20 wound on both of the rolls. In addition, an intermediate transfer member cleaning device 30 opposed to the driving roll 22 is provided on a surface of the intermediate transfer belt 20 on the image holding member side.

Developing devices (developing units) 4Y, 4M, 4C, and 4K of the units 10Y, 10M, 10C, and 10K are supplied with toners including four colors of toner, that is, a yellow toner, a magenta toner, a cyan toner, and a black toner accommodated in toner cartridges 8Y, 8M, 8C, and 8K, respectively.

The first to fourth units 10Y, 10M, 10C, and 10K have the same configuration, and accordingly, only the first unit 10Y that is disposed on the upstream side in a traveling direction of the intermediate transfer belt to form a yellow image will be representatively described herein. The same parts as in the first unit 10Y will be denoted by the reference numerals with magenta (M), cyan (C), and black (K) added instead of yellow (Y), and descriptions of the second to fourth units 10M, 10C, and 10K will be omitted.

The first unit 10Y has a photoreceptor 1Y acting as an image holding member. Around the photoreceptor 1Y, a charging roll (an example of the charging unit) 2Y that charges a surface of the photoreceptor 1Y to a predetermined potential, an exposure device (an example of the electrostatic charge image forming unit) 3 that exposes a charged surface with laser beams 3Y based on a color-separated image signal to form an electrostatic charge image, a developing device (an example of the developing unit) 4Y that supplies a charged toner to the electrostatic charge image to develop the electrostatic charge image, a primary transfer roll (an example of the primary transfer unit) 5Y that transfers the developed toner image onto the intermediate transfer belt 20, and a photoreceptor cleaning device (an example of the cleaning unit) 6Y that removes the toner remaining on the surface of the photoreceptor 1Y after primary transfer, are arranged in sequence.

The primary transfer roll 5Y is disposed inside the intermediate transfer belt 20 to be provided at a position opposed to the photoreceptor 1Y. Furthermore, bias suppliers (not shown) that apply a primary transfer bias are connected to the primary transfer rolls 5Y, 5M, 5C, and 5K, respectively. Each bias supplier changes a transfer bias that is applied to each primary transfer roll under the control of a controller (not shown).

Hereinafter, an operation of forming a yellow image in the first unit 10Y will be described.

First, before the operation, the surface of the photoreceptor 1Y is charged to a potential of −600 V to −800 V by the charging roll 2Y.

The photoreceptor 1Y is formed by laminating a photosensitive layer on a conductive substrate (for example, volume resistivity at 20° C.: 1×10⁻⁶ Ωcm or less). The photosensitive layer typically has high resistance (that is about the same as the resistance of a general resin), but has properties in which when laser beams 3Y are applied, the specific resistance of a part irradiated with the laser beams changes. Accordingly, the laser beams 3Y are output to the charged surface of the photoreceptor 1Y via the exposure device 3 in accordance with image data for yellow sent from the controller (not shown). The laser beams 3Y are applied to the photosensitive layer on the surface of the photoreceptor 1Y, whereby an electrostatic charge image of a yellow image pattern is formed on the surface of the photoreceptor 1Y.

The electrostatic charge image is an image that is formed on the surface of the photoreceptor 1Y by charging, and is a so-called negative latent image, that is formed by applying laser beams 3Y to the photosensitive layer so that the specific resistance of the irradiated part is lowered to cause charges to flow on the surface of the photoreceptor 1Y, while charges stay on a part to which the laser beams 3Y are not applied.

The electrostatic charge image formed on the photoreceptor 1Y is rotated up to a predetermined developing position with the travelling of the photoreceptor 1Y. The electrostatic charge image on the photoreceptor 1Y is visualized (developed) as a toner image at the developing position by the developing device 4Y.

The developing device 4Y accommodates, for example, an electrostatic charge image developer including at least a yellow toner and a carrier. The yellow toner is frictionally charged by being stirred in the developing device 4Y to have a charge with the same polarity (negative polarity) as the charge that is on the photoreceptor 1Y, and is thus held on the developer roll (an example of the developer holding member). By allowing the surface of the photoreceptor 1Y to pass through the developing device 4Y, the yellow toner electrostatically adheres to the erased latent image part on the surface of the photoreceptor 1Y, whereby the latent image is developed with the yellow toner. Next, the photoreceptor 1Y having the yellow toner image formed thereon travels at a predetermined speed and the toner image developed on the photoreceptor 1Y is transported to a predetermined primary transfer position.

When the yellow toner image on the photoreceptor 1Y is transported to the primary transfer position, a primary transfer bias is applied to the primary transfer roll 5Y and an electrostatic force toward the primary transfer roll 5Y from the photoreceptor 1Y acts on the toner image, whereby the toner image on the photoreceptor 1Y is transferred onto the intermediate transfer belt 20. The transfer bias applied at this time has the opposite polarity (+) to the toner polarity (−), and, for example, is controlled to be +10 μA in the first unit 10Y by the controller (not shown).

Meanwhile, the toner remaining on the photoreceptor 1Y is removed and collected by the photoreceptor cleaning device 6Y.

The primary transfer biases that are applied to the primary transfer rolls 5M, 5C, and 5K of the second unit 10M and the subsequent units are also controlled in the same manner as in the case of the first unit.

In this manner, the intermediate transfer belt 20 onto which the yellow toner image is transferred in the first unit 10Y is sequentially transported through the second to fourth units 10M, 10C, and 10K, and the toner images of respective colors are multiply-transferred in a superimposed manner.

The intermediate transfer belt 20 onto which the four color toner images have been multiply-transferred through the first to fourth units reaches a secondary transfer part that is composed of the intermediate transfer belt 20, the support roll 24 contacting the inner surface of the intermediate transfer belt, and a secondary transfer roll (an example of the secondary transfer unit) 26 disposed on the image holding surface side of the intermediate transfer belt 20. Meanwhile, a recording sheet (an example of the recording medium) P is supplied to a gap between the secondary transfer roll 26 and the intermediate transfer belt 20, that are brought into contact with each other, via a supply mechanism at a predetermined timing, and a secondary transfer bias is applied to the support roll 24. The transfer bias applied at this time has the same polarity (−) as the toner polarity (−), and an electrostatic force toward the recording sheet P from the intermediate transfer belt 20 acts on the toner image, whereby the toner image on the intermediate transfer belt 20 is transferred onto the recording sheet P. In this case, the secondary transfer bias is determined depending on the resistance detected by a resistance detector (not shown) that detects the resistance of the secondary transfer part, and is voltage-controlled.

Thereafter, the recording sheet P is fed to a pressure-contacting part (nip part) between a pair of fixing rolls in a fixing device (an example of the fixing unit) 28 so that the toner image is fixed to the recording sheet P, whereby a fixed image is formed.

Examples of the recording sheet P onto which a toner image is transferred include plain paper that is used in electrophotographic copying machines, printers, and the like. As a recording medium, an OHP sheet is also exemplified other than the recording sheet P.

The surface of the recording sheet P is preferably smooth in order to further improve smoothness of the image surface after fixing. For example, coating paper obtained by coating a surface of plain paper with a resin or the like, art paper for printing, and the like are preferably used.

The recording sheet P on which the fixing of the color image is completed is discharged toward a discharge part, and a series of the color image forming operations end.

Process Cartridge/Toner Cartridge

A process cartridge according to the exemplary embodiment will be described.

The process cartridge according to the exemplary embodiment is provided with a developing unit that accommodates the electrostatic charge image developer according to the exemplary embodiment and develops an electrostatic charge image formed on a surface of an image holding member with the electrostatic charge image developer to form a toner image, and is detachable from an image forming apparatus.

The process cartridge according to the exemplary embodiment is not limited to the above-described configuration, and may be configured to include a developing device, and if necessary, at least one selected from other units such as an image holding member, a charging unit, an electrostatic charge image forming unit, and a transfer unit.

Hereinafter, an example of the process cartridge according to the exemplary embodiment will be illustrated. However, this process cartridge is not limited thereto. Major parts shown in the drawing will be described, but descriptions of other parts will be omitted.

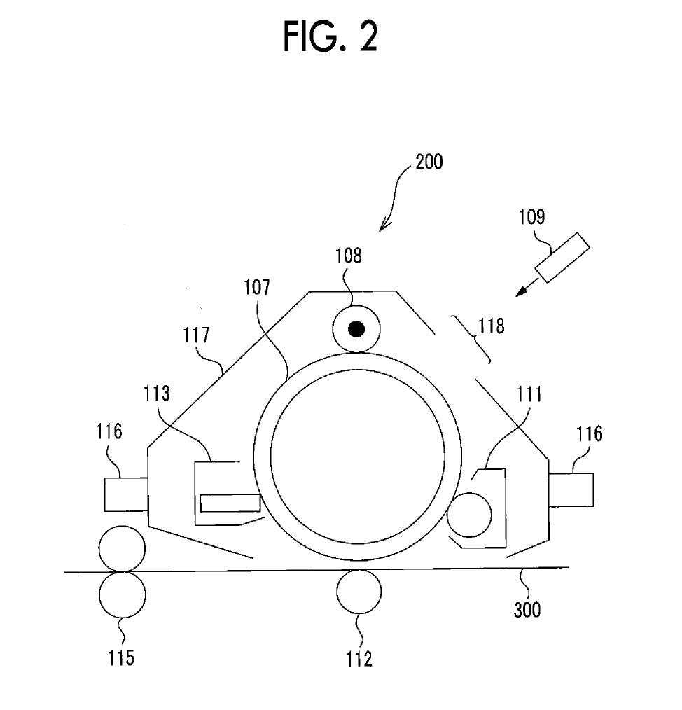

FIG. 2 is a schematic diagram showing a configuration of the process cartridge according to the exemplary embodiment.

A process cartridge 200 shown in FIG. 2 is formed as a cartridge having a configuration in which a photoreceptor 107 (an example of the image holding member), a charging roll 108 (an example of the charging unit), a developing device 111 (an example of the developing unit), and a photoreceptor cleaning device 113 (an example of the cleaning unit), which are provided around the photoreceptor 107, are integrally combined and held by the use of, for example, a housing 117 provided with a mounting rail 116 and an opening 118 for exposure.

In FIG. 2, the reference numeral 109 represents an exposure device (an example of the electrostatic charge image forming unit), the reference numeral 112 represents a transfer device (an example of the transfer unit), the reference numeral 115 represents a fixing device (an example of the fixing unit), and the reference numeral 300 represents a recording sheet (an example of the recording medium).

Next, a toner cartridge according to the exemplary embodiment will be described.

The toner cartridge according to the exemplary embodiment accommodates the toner according to the exemplary embodiment and is detachable from an image forming apparatus. The toner cartridge accommodates a toner for replenishment for supply to the developing unit provided in the image forming apparatus.

The image forming apparatus shown in FIG. 1 has such a configuration that the toner cartridges 8Y, 8M, 8C, and 8K are detachable therefrom, and the developing devices 4Y, 4M, 4C, and 4K are connected to the toner cartridges corresponding to the respective developing devices (colors) via toner supply tubes (not shown), respectively. In addition, when the toner accommodated in the toner cartridge runs low, the toner cartridge is replaced.

### EXAMPLES

Hereinafter, the exemplary embodiment will be described in detail using examples and comparative examples, but is not limited to these examples. In the following description, unless specifically noted, “parts” and “%” are based on weight.

### Example 1

### Preparation of Toner Particles

### Toner Particles 1

Preparation of Polyester Resin Dispersion
Ethylene glycol (manufactured by Wako Pure Chemical Industries, Ltd.): 37 parts
Neopentyl glycol (manufactured by Wako Pure Chemical Industries, Ltd.): 65 parts
1,9-Nonanediol (manufactured by Wako Pure Chemical Industries, Ltd.): 32 parts
Terephthalic acid (manufactured by Wako Pure Chemical Industries, Ltd.): 96 parts

The monomers are put into a flask and heated to a temperature of 200° C. for 1 hour, and it is checked that stirring is performed in the reaction system, and then, 1.2 parts of dibutyl tin oxide is added thereto. In addition, the temperature is increased from that temperature to 240° C. for 6 hours while distilling away the formed water, and dehydration condensation reaction is allowed to continue further at 240° C. for 4 hours, to obtain a polyester resin A having an acid value of 9.4 mg KOH/g, a weight average molecular weight of 13,000, and a glass transition temperature of 62° C.

Next, the polyester resin A is transported to a CAVITRON CD1010 (manufactured by Eurotec Ltd.) at a rate of 100 parts per minute, in a melted state. Diluted aqueous ammonia having a concentration of 0.37% obtained by diluting reagent aqueous ammonia with ion exchange water is put into an aqueous medium tank provided separately, and the resultant material is transported to the CAVITRON at the same time as the polyester molten resin, at a rate of 0.1 liters per minute, while heating to 120° C. in a heat exchanger. The CAVITRON is operated under the conditions of a rotation rate of a rotator of 60 Hz and pressure of 5 kg/cm², and an amorphous polyester resin particle dispersion in which resin particles having a volume average particle diameter of 160 nm, a solid content of 30%, a glass transition temperature of 62° C., and a weight average molecular weight Mw of 13,000 are dispersed, is obtained.

Preparation of Colorant Dispersion 1
Cyan pigment (C.I. Pigment Blue 15:3 manufactured by Dainichiseika Color & Chemicals Mfg. Co., Ltd.): 10 parts
Anionic surfactant (NEOGEN SC manufactured by Dai-Ichi Kogyo Seiyaku Co., Ltd.): 2 parts
Ion exchange water: 80 parts

The above components are mixed and dispersed using a high-pressure impact type disperser ULTTMIZER (HJP30006 manufactured by SUGINO MACHINE LIMITED) for 1 hour, and a colorant dispersion having a volume average particle diameter of 180 nm and a solid content of 20% is obtained.

Preparation of Release Agent Dispersion
Paraffin Wax (HNP 9 manufactured by Nippon Seiro Co., Ltd.): 50 parts
Anionic surfactant (NEOGEN SC manufactured by Dai-Ichi Kogyo Seiyaku Co., Ltd.): 2 parts
Ion exchange water: 200 parts

The above components are heated to 120° C., sufficiently mixed and dispersed using an ULTRA TURRAX T50 manufactured by IKA Japan, K.K., and then are subjected to a dispersion treatment using a pressure discharge type homogenizer, and a release agent dispersion having a volume average particle diameter of 200 nm and a solid content of 20% is prepared.

Preparation of Toner Particles 1
Polyester resin dispersion: 200 parts
Colorant dispersion 1: 25 parts
Polyaluminum chloride: 0.4 parts
Ion exchange water: 100 parts

The above components are put into a stainless steel flask, sufficiently mixed and dispersed using an ULTRA TURRAX manufactured by IKA Japan, K.K., and then heated to 48° C. while stirring the components in the flask in an oil bath for heating. After holding the mixture at 48° C. for 30 minutes, 70 parts of the polyester resin particle dispersion described above is gently added thereto.

Then, after adjusting the pH to 8.0 in the system using aqueous sodium hydroxide having a concentration of 0.5 mol/L, the stainless steel flask is sealed, the seal of the stirring shaft is sealed with a magnetic force, and the mixture is heated to 90° C. while stirring and held for 3 hours. After completing the reaction, the mixture is cooled at a cooling rate of 2° C./rain, filtered, and sufficiently washed with ion exchange water, and solid-liquid separation is performed by Nutsche-type suction filtration. In addition, the solid content is dispersed again using 3 L of ion exchange water at 30° C., stirred and washed at 300 rpm for 15 minutes. This washing operation is repeated 6 times. When the pH of the filtrated liquid is 7.54 and electrical conductivity is 6.5 μS/cm, the solid-liquid separation is performed by Nutsche-type suction filtration using No. 5A filter paper. Next, vacuum drying is continued for 12 hours, and the toner particles 1 are obtained.

When the volume average particle diameter D50v of the toner particles (1) is measured with a Coulter counter, the volume average particle diameter D50v is 5.8 μm and SF1 is 130.

Preparation of External Additive

Strontium Titanate Particles 1

Sulfuric acid and pure water are added to a solution obtained by dissolving titania sulfate so as to have an acid concentration of 1.0 (mol/l), and the acid concentration is adjusted to 1.5 (mol/l), hydrolysis is allowed to proceed at 100° C. for 40 hours while stirring the mixture at a stirring rate of 20 rpm, and metatitanic acid slurry is obtained. After washing the metatitanic acid slurry, strontium carbonate is added to have an equimolar amount, and mixing is performed at 30° C. for 24 hours while stirring at a stirring rate of 150 rpm, and strontium titanate slurry is obtained. After washing the obtained slurry with water, the slurry is burned at 700° C. for 5 hours and is subjected to a coarse powder removing step by mechanical pulverization and classification, and accordingly, strontium titanate particles 1 to be used in Example 1 which has a volume average particle diameter of 850 nm, a maximum peak at a Bragg angle of 32.2°, and a half-value width of the peak of 0.7 degrees is obtained.

Strontium Titanate Particles 2

In the conditions of the strontium titanate particles 1, the temperature and the time of the burning conditions are changed to 600° C. and 3 hours, and accordingly, strontium titanate 2 to be used in Example 2 which has a volume average particle diameter of 850 nm, a maximum peak at a Bragg angle of 32.2°, and a half-value width of the peak of 1.8 degrees is obtained.

Strontium Titanate Particles 3

In the conditions of the strontium titanate particles 1, the stirring rate after adding strontium carbonate is changed to 20 rpm, and accordingly, strontium titanate particles 3 to be used in Example 3 which has a volume average particle diameter of 9,500 nm, a maximum peak at a Bragg angle of 32.2°, and a half-value width of the peak of 0.5 degrees is obtained.

Strontium Titanate Particles 4

In the conditions of the strontium titanate particles 1, the stirring rate after adding strontium carbonate is changed to 20 rpm, the temperature and the time of the burning conditions are changed to 600° C. and 3 hours, and accordingly, strontium titanate particles 4 to be used in Example 4 which has a volume average particle diameter of 9,500 nm, a maximum peak at a Bragg angle of 32.2°, and a half-value width of the peak of 1.6 degrees is obtained.

Strontium Titanate Particles 5

In the conditions of the strontium titanate particles 1, the stirring rate after adding strontium carbonate is changed to 120 rpm, the temperature and the time of the burning conditions are changed to 650° C. and 4 hours, and accordingly, strontium titanate particles 5 to be used in Example 5 which has a volume average particle diameter of 2,200 nm, a maximum peak at a Bragg angle of 32.2°, and a half-value width of the peak of 1.45 degrees is obtained.

Strontium Titanate Particles 6

In the conditions of the strontium titanate particles 1, the temperature and the time of the burning conditions are changed to 600° C. and 2 hours, and accordingly, strontium titanate particles 6 to be used in Example 6 which has a volume average particle diameter of 850 nm, a maximum peak at a Bragg angle of 32.2°, and a half-value width of the peak of 2.1 degrees is obtained.

Strontium Titanate Particles C1

In the conditions of the strontium titanate particles 1, the stirring rate after adding strontium carbonate is changed to 200 rpm, the temperature and the time of the burning conditions are changed to 850° C. and 5 hours, and accordingly, strontium titanate particles C1 to be used in Comparative Example 1 which has a volume average particle diameter of 300 nm, a maximum peak at a Bragg angle of 32.2°, and a half-value width of the peak of 0.2 degrees is obtained.

Strontium Titanate Particles C2

In the conditions of the strontium titanate particles 1, the stirring rate after adding strontium carbonate is changed to 200 rpm, the temperature and the time of the burning conditions are changed to 700° C. and 5 hours, and accordingly, strontium titanate particles C2 to be used in Comparative Example 2 which has a volume average particle diameter of 300 nm, a maximum peak at a Bragg angle of 32.2°, and a half-value width of the peak of 0.7 degrees is obtained.

Strontium Titanate Particles C3

In the conditions of the strontium titanate particles 1, the temperature and the time of the burning conditions are changed to 850° C. and 5 hours, and accordingly, strontium titanate particles C3 to be used in Comparative Example 3 which has a volume average particle diameter of 850 nm, a maximum peak at a Bragg angle of 32.2°, and a half-value width of the peak of 0.2 degrees is obtained.

Strontium Titanate Particles C4

In the conditions of the strontium titanate particles 1, the stirring rate after adding strontium carbonate is changed to 10 rpm, the temperature and the time of the burning conditions are changed to 650° C. and 5 hours, and accordingly, strontium titanate particles C4 to be used in Comparative Example 4 which has a volume average particle diameter of 12,000 nm, a maximum peak at a Bragg angle of 32.2°, and a half-value width of the peak of 0.8 degrees is obtained.

### Examples 1 to 6 and Comparative Examples 1 to 4

According to combinations of Table 1, 0.2 parts by weight of strontium titanate particles and 3.0 parts by weight of silica particles (A200 manufactured by Aerosil Nippon Co., Ltd.), as the external additives, are added to 20 parts by weight of toner particles, and mixing is performed at 2,000 rpm for 3 minutes using a Henschel mixer, and each toner is obtained.

Each obtained toner and carrier are put in a V-blender at a ratio of toner:carrier=5:95 (weight ratio), and stirred for 20 minutes, and a developer is obtained.

The carrier prepared as follows is used.

1000 parts of Mn—Mg ferrite (manufactured by Powdertech, volume average particle diameter: 50 μm, shape factor SF1: 120) is put in a kneader, and 150 parts of a perfluorooctyl methyl acrylate-methyl methacrylate copolymer (manufactured by Soken Chemical Engineering Co., Ltd., polymerization ratio: 20/80, Tg: 72° C., weight average molecular weight: 72,000) is added to a solution dissolved in 700 parts of toluene, and these are mixed at a room temperature for 20 minutes, heated at 70° C., dried by reducing pressure, and extracted, to obtain a coated carrier. The obtained coated carrier is sieved with a sieve having an aperture of 75 μm, the coarse powder is removed, and the carrier is obtained. The shape factor SF1 of the carrier is 122.

Evaluation

The colored stripe and the dullness of color are evaluated using the obtained developer in each Example. The results are shown in Table 1. When the following results for both evaluations are G1 to G3, this is an acceptable level.

Evaluation of Colored Stripe

The evaluation of the colored stripe is performed as follows.

The obtained developer is kept in an environment of low temperature and low humidity (10° C. and 15% RH) for 3 days.

After that, a 700 DIGITAL COLOR PRESS developing device (manufactured by Fuji Xerox Co., Ltd.) is filled with the developer, and 100,000 images having an area coverage of 1% are output. The environment in this case is 28.5° C. and 85% RH.

Regarding 100 images which are from the output 99,901^{st} to 100,000^{th} images, the generation of the colored stripe is visually observed and the number of sheets having the generated colored stripe is counted.

The evaluation criteria are as follows.

Evaluation Criteria

G1: No colored stripe generated

G2: 5 sheets or less having the colored stripe generated

G3: 6 sheets to 10 sheets having the colored stripe generated

G4: 11 sheets or more having the colored stripe generated

Evaluation of Dullness of Color

The dullness of color is evaluated as follows.

1 sheet with a 5 cm×5 cm solid image patch is output using a 700 DIGITAL COLOR PRESS filled with the obtained developer (sample 1), 100,000 images having an area coverage of 5% are output, and 1 sheet with the 5 cm×5 cm solid image patch is output again (sample 2).

The color gamut (L*, a*, b*) of the sample 1 and the sample 2 is measured. The color gamut is measured with an image densitometer X-RITE 938 (manufactured by X-Rite, Incorporated).

From a difference in color gamut between the sample 2 and the sample 1, ΔE is calculated using the following formula, and this is set as an index of the evaluation of the dullness of color.

ΔE=[(ΔL*)²+(Δa*)⁺+(Δb*)²]^{1/2}

Herein, ΔL*=(L* of sample 2−L* of sample 1), Δa*=(a* of sample 2−a* of sample 1), Δb*=(b* of sample 2−b* of sample 1).

The evaluation criteria are as follows.

Evaluation Criteria

G1: ΔE≦3.0

G2: 3.0<ΔE≦6.0

G3: 6.0<ΔE≦10

G4: ΔE>10

TABLE 1

| | | Strontium titanate particles | | | | |
|---|---|---|---|---|---|---|
| | Toner | | Particle | Half-value | Evaluation | |
| | Particle | | diameter | width | Colored | Dullness |
| | No. | No. | (nm) | (degree) | stripe | of color |
| Ex. 1 | 1 | 1 | 850 | 0.7 | G2 | G2 |
| Ex. 2 | 1 | 2 | 850 | 1.8 | G2 | G2 |
| Ex. 3 | 1 | 3 | 9500 | 0.5 | G1 | G3 |
| Ex. 4 | 1 | 4 | 9500 | 1.6 | G2 | G2 |
| Ex. 5 | 1 | 5 | 2200 | 1.45 | G1 | G1 |
| Ex. 6 | 1 | 6 | 850 | 2.1 | G3 | G2 |
| Com. | 1 | C1 | 300 | 0.2 | G3 | G4 |
| Ex. 1 | | | | | | |
| Com. | 1 | C2 | 300 | 0.7 | G4 | G2 |
| Ex. 2 | | | | | | |
| Com. | 1 | C3 | 850 | 0.2 | G3 | G4 |
| Ex. 3 | | | | | | |
| Com. | 1 | C4 | 12000 | 0.8 | G1 | G4 |
| Ex. 4 | | | | | | |

From the above results, it is found that, the generation of both the colored stripe and the dullness of color is prevented in Examples, compared to Comparative Examples.

Particularly, it is also found that the generation of the colored stripe is further prevented, by using the strontium titanate particles having a half-value width equal to or smaller than 2.0 degrees.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles containing a binder resin and a colorant; and
strontium titanate particles,
wherein the strontium titanate particles have a volume average particle diameter of 800 nm to 10,000 nm, a maximum peak at a Bragg angle of 32.2° in CuKα characteristic X-ray diffraction, and a half-value width of the maximum peak equal to or greater than 0.5 degrees.

2. The electrostatic charge image developing toner according to claim 1,
wherein the half-value width of the maximum peak of the strontium titanate particles is from 0.5 degrees to 2.0 degrees.

3. The electrostatic charge image developing toner according to claim 1,
wherein the volume average particle diameter of the strontium titanate particles is from 1,000 nm to 5,000 nm.

4. The electrostatic charge image developing toner according to claim 1,
wherein the half-value width of the maximum peak of the strontium titanate particles is from 0.7 degrees to 1.7 degrees.

5. The electrostatic charge image developing toner according to claim 1, further comprising:
an external additive,
wherein a weight ratio between the strontium titanate particles and the external additive (strontium titanate particles/external additive) is in a range of 0.005 to 0.1.

6. An electrostatic charge image developer comprising:
the electrostatic charge image developing toner according to claim 1 and a carrier.

7. A developer cartridge comprising:
a container which accommodates the electrostatic charge image developer according to claim 6,
wherein the developer cartridge is detachable from an image forming apparatus.

8. A process cartridge comprising:
a developing unit that accommodates the electrostatic charge image developer according to claim 6 and develops an electrostatic charge image formed on a surface of an image holding member as a toner image with the electrostatic charge image developer,
wherein the process cartridge is detachable from an image forming apparatus.

9. An image forming apparatus comprising:
an image holding member;
a charging unit that charges a surface of the image holding member;
an electrostatic charge image forming unit that forms an electrostatic charge image on a charged surface of the image holding member;
a developing unit that accommodates the electrostatic charge image developer according to claim 6 and develops the electrostatic charge image formed on the surface of the image holding member as a toner image with the electrostatic charge image developer;
a transfer unit that transfers the toner image formed on the surface of the image holding member onto a surface of a recording medium; and
a fixing unit that fixes the toner image transferred onto the surface of the recording medium.
